(19) United States
(12) Patent Application Publication
(10) Pub. No.: US 2005/0180907 A1
(43) Pub. Date: Aug. 18, 2005

(54) Method of converting green house gases from fossil fuels into non-toxic base elements

(76) Inventors: Robert R. Holcomb, Nashville, TN (US); Andrew R. Holcomb, Nashville, TN (US)

Correspondence Address: GARVEY, SMITH, NEHRBASS & DOODY, L.L.C., Suite 3290, 3838 N. Causeway Blvd., Metairie, LA, 70002, US

(21) Appl. No.: 11/044,898

(22) Filed: Jan. 27, 2005

Related U.S. Application Data
(60) Provisional application No. 60/539,635, filed on Jan. 28, 2004.

(51) Int. Cl. B01D 53/62

(52) U.S. Cl. 423/246

(57) ABSTRACT

A process which includes the steps of first collecting the green house gases, such as CO₂, SO₂, Nox, CO, emitted from a furnace where fossil fuels are burned; flowing the gases to a sequestration unit where the gases are cleaned and scrubbed; moving the scrubbed gases to a compressor for reducing the volume of the gases; introducing the gases into a plasma arc for ionizing the gases to charged components; providing a source of free electrons; capturing the free electrons in a dense free electron zone; introducing the charged components from the plasma arc into the dense free electron zone for rendering the ions into elemental fragments of carbon, oxygen gas, nitrogen, hydrocarbons, and other elemental components; collecting the elemental fragments of carbon and other elements; routing the oxygen gas to the furnace to provide oxygen to burn additional fossil fuels.

### CROSS-REFERENCE TO RELATED APPLICATIONS

This application claims priority from the provisional patent application entitled “Method of Converting Green House Gases from Fossil Fuels into Non-toxic Base Element”, bearing Ser. No. 60/539,635, filed Jan. 28, 2004, which is fully incorporated herein by reference thereto.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to treatment of green house gases. More particularly, the present invention relates to a process for converting green house gases, such as carbon dioxide, carbon monoxide, sulfur dioxide, nitrous oxide and others, emitted from burning fossil fuels, to their base components of elemental carbon, sulfur, nitrogen and oxygen, while eliminating all emissions of harmful green house gases into the atmosphere.

2. General Background of the Invention

Coal is the most bountiful source of fuel in the world. Coal makes up 90% of the available fossil fuel in the world. Coal is typically found as a dark brown to black graphite like material that is formed from fossilized plant matter. Coal generally comprises amorphous carbon combined with some organic and inorganic compounds. The quality and type of coal varies from high quality anthracite (i.e. a high carbon content with few volatile impurities and burns with a clean flame) to bituminous (i.e., a high percentage of volatile impurities and burns with a murky flame) to sub-bituminous (i.e., lower percentage of volatile impurities but higher ash and moisture) to lignite (i.e. softer than bituminous coal and comprising vegetable matter not as fully converted to carbon and burns with a very smoky flame). Coal is burned in coal-fired power plants throughout the world to produce energy in the form of electricity. Over the years, it has been recognized that certain impurities in coal can have a significant impact on the types of emissions produced during coal combustion. A particularly troublesome impurity is sulfur. Sulfur can be present in coal from trace amounts up to several percentages by weight (e.g., 0-7 percent by weight) Sulfur may be found in coal in various forms, e.g. organic sulfur, pyretic sulfur, or sulfate sulfur. When coal-containing sulfur is burned, sulfur dioxide (SO₂) is typically released into the atmosphere in the combustion gases. The presence of SO₂ in the atmosphere has been linked to the formation of acid rain, which results in part from sulfuric or sulfurous acids that from SO₂ and water. Acid rain can damage the environment in a variety of ways. And in the United States, the Environmental Protection agency (EPA) has standards for burning coal that restricts SO₂ emissions from coal-fired power plants.

While coal is produced in the United States in many area of the country, much of the coal that is easily mined (and therefore inexpensive) often contains high levels of sulfur that result in levels of SO₂ in the combustion gases greater than allowed by the EPA. Thus, coal-fired plants often must buy higher quality coal from mines that may be located long distances from the plants and pay significant transportation and other costs. A significant body of technology has been developed over time to reduce the amount of SO₂ in combustion gases from burning high sulfur coal. This technology has involved treatments to coal during pre-combustion, during combustion, and during post combustion. However, such treatments have generally not achieved a satisfactory combination of efficacy in reducing SO₂ emissions and economic feasibility in implementation.

When coal is burned in the presence of air at the burn temperature of modern boilers, the nitrogen from the air forms covalent bonds with oxygen to form nitrous oxide (NO and NO₂) or Nox. Nitrous oxide is a major component of acid rain. Total Nox emissions from coal-fired boilers are about 6.8 million tons/year, equivalent to an emissions rate of 0.75 Ib/million BTU. Nox reduction technologies have been developed but with disappointing outcomes. 1) Low-Nox burners. 2) Selective catalytic and non-catalytic reduction technologies (SCR). 3) Artificial intelligence-based control systems.

Most coal deposits contain varying amounts of mercury. When the coal is burned much of this mercury is emitted in the flue gas. This mercury is brought back to the earth in rainwater. This contamination of our surface water has allowed toxic concentrations of mercury to accumulate in the fish, such that the fish may be unfit for human consumption. No good technology is available to control these mercury emissions.

For each ton of coal burned in the world each year, one ton of CO₂ (carbon dioxide) is produced and released into the atmosphere. It is estimated that approximately 4.0 Billion tons of CO₂ are released into the atmosphere each year from the burn of coal. No significant technology exists to prevent the release of this significant green house gas.

It is against this background that a need arose to develop the process of the present invention.

### BRIEF SUMMARY OF THE INVENTION

The present invention solves the problems of treating and converting green house gases to non-toxic elements in a straightforward manner. What is provided is a process which includes the steps of first collecting the green house gases, such as CO₂, SO₂, Nox, CO, emitted from a furnace where fossil fuels are burned; flowing the gases to a sequestration unit where the gases are cleaned and scrubbed; moving the scrubbed gases to a compressor for reducing the volume of the gases; introducing the gases into a plasma arc for ionizing the gases to charged components; providing a source of free electrons; capturing the free electrons in a dense free electron zone; introducing the charged components from the plasma arc into the dense free electron zone for rendering the ions into elemental fragments of carbon, oxygen gas, nitrogen, hydrocarbons, and other elemental components; collecting the elemental fragments of carbon and other elements; routing the oxygen gas to the furnace to provide oxygen to burn additional fossil fuels.

It is a principal object of the present invention to provide a process for rendering toxic green house gases released from burning of fossil fuels to harmless elemental components;

It is a further object of the present invention to provide a process of converting green house gases into elemental fragments within a closed loop system, free of emissions;

It is a further object of the present invention to provide a process which allows the conversion of green house gases into non-toxic components;

It is a further object of the present invention to provide a process for avoiding emissions of green house gases, such as CO₂, CO, SO₂, and others into the atmosphere as a result of burning fossil fuels;

It is a further object of the present invention to provide a process which includes a sequestration unit in which green house gases are cleaned and scrubbed for further processing into elemental fragments.

With the method and system of the present invention, at least 10% of the green house gases are converted to non-harmful components. Preferably, at least 20% of the green house gases are converted to non-harmful components. More preferably, at least 50% of the green house gases are converted to non-harmful components. Even more preferably, at least 90+% of the green house gases are converted to non-harmful components. Most preferably, all or substantially all green house gases are converted to non-harmful components.

While most preferably all or substantially all green house gases are converted to non-harmful components, the invention is useful and desirable even if only 50%, 60%, 70%, 80%, or 90%, for example, of gases are converted.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is an illustration of the components included in the process of the present invention of converting green house gases to the elemental components;

FIG. 2 is a representation of the closed loop sequestration unit for the sequestration of CO₂ for production of calcium carbonate and IPE;

FIG. 3 is a partial view of the conversion of the ionized green house gas components to stable elemental components;

FIG. 4 is an isolated view of the tower for collecting the free electrons and converting the charged ions into elemental fragments;

FIG. 5 is a Comparison of CO₂ Concentrations for IPE Treated Coal;

FIG. 6 is a Comparison of CO₂ Concentrations for Untreated Coal;

FIG. 7 is a Comparison of O₂ Concentrations for IPE Treated Coal;

FIG. 8 is a Comparison of O₂ Concentrations for Untreated Coal; and

FIG. 9 illustrates the Carbon Cycle of Energy.

### DETAILED DESCRIPTION OF THE INVENTION

The Holcomb Scientific Zero Emissions Prototype Power Plant represents the clean power of the future, which is available today. It utilizes the existing infrastructure to burn fossil fuels such as coal, oil and gas without releasing emissions into the atmosphere. With this technology there will be no abnormal levels of green house gases above those required for the natural balance of the earth.

The combustion process begins in the furnace where heat or thermal energy is generated and then converted to usable power. The furnace is also where the problem of dangerous emissions begins. These dangerous emissions, in the form of gases, make up what we know today as smog, greenhouse gases and the gases of acid rain, the harmful byproducts that plague our world today.

From the furnace the gases follow the piping system through the circulation fans into the sequestration chamber. In the sequestration chamber the gaseous byproducts of combustion are partially removed along with toxic substances such as mercury, which is completely removed.

The remaining scrubbed gases are then compressed and injected through the plasma arc where the oxygen, carbon, nitrogen, and sulfur bonds are broken. Breaking the bonds in these dangerous gases releases oxygen and the base elements of the gases in an ionized form. The electron accelerator stabilizes the ionized gases by bombarding them with an excess number of electrons, which takes place in a magnetic chamber.

The base elements are separated in the element trap and the oxygen then proceeds along to the combustion chamber where it is reused to combust additional fossil fuel.

The cycle continues in this truly closed loop system without any emissions while continuously producing energy.

This is the solution to the green house gas problem. It also eliminates toxic gases currently produced from the burning of fossil fuels. The unit can be scaled down into the size of the furnace alone for home or small business applications, or be scaled up to accommodate Industrial and Power Grid applications. The Holcomb Scientific Zero Emissions Prototype Power Plant represents the clean power of the future that is available today.

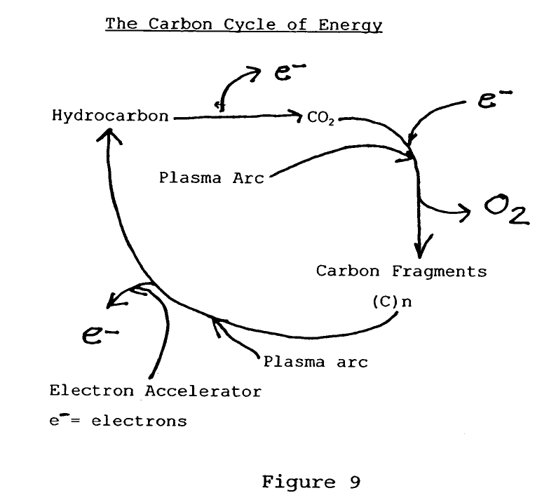

What follows is a summary of the theory and operation of the process of the present invention as illustrated in FIG. 9, The Carbon Cycle of Energy. As seen, hydrocarbons are combusted in the presence of oxygen to form carbon dioxide, thermal energy in the form of high frequency electrons and water. The carbon dioxide is ionized in a plasma arc forming carbon devoid of outer orbital electrons and ionized oxygen. Re-oxidation is competitively inhibited by providing a large excess of electrons in the area of the ionization process. Carbon fragments such as carbon black are collected and the O₂ is available to go back to the reaction chamber.

The carbon fragments are dissolved in a solution of IPE (a catalytic surface) and water. The carbon fragment solution is then passed through a plasma arc in the presence of nitrogen (oxygen free) into an electron accelerator. The accelerator provides an environment devoid of free electrons. Therefore, the carbon forms combustible hydrocarbon such as long chain oils, to be a power source for the conversion in either solar and/or the “Holcomb Power Cell.” The Carbon-Carbon, Carbon-Hydrogen and Carbon Oxygen covalent bonds as a storage battery for stable long term storage of electricity.

Turning now to the specifics of the invention, in the preferred embodiment of the present invention, there is provided a method, in real time and on line, to convert green house gases, including CO₂, SO₂, Nox, CO, and hydrocarbons, to their base elements in a closed loop system. In a provisional application entitled “Emissions Free High Efficiency Coal Fired Power Generation Plant,” currently pending, by the same inventors, and incorporated by reference thereto, there was disclosed some aspects of the present invention. However, the process of the invention disclosed herein provides for combustion of any fossil fuels efficiently which results in zero emissions to the environment. In the process, CO₂ and other green house gases, are converted to oxygen, nitrogen, and carbon fragments, including carbon black, graphite, combustible gases, although not all have yet been identified. The process also results in the production of a light to medium grade oil, which appears to be in the category light crude oil, appearing in the pressure tanks and the lines.

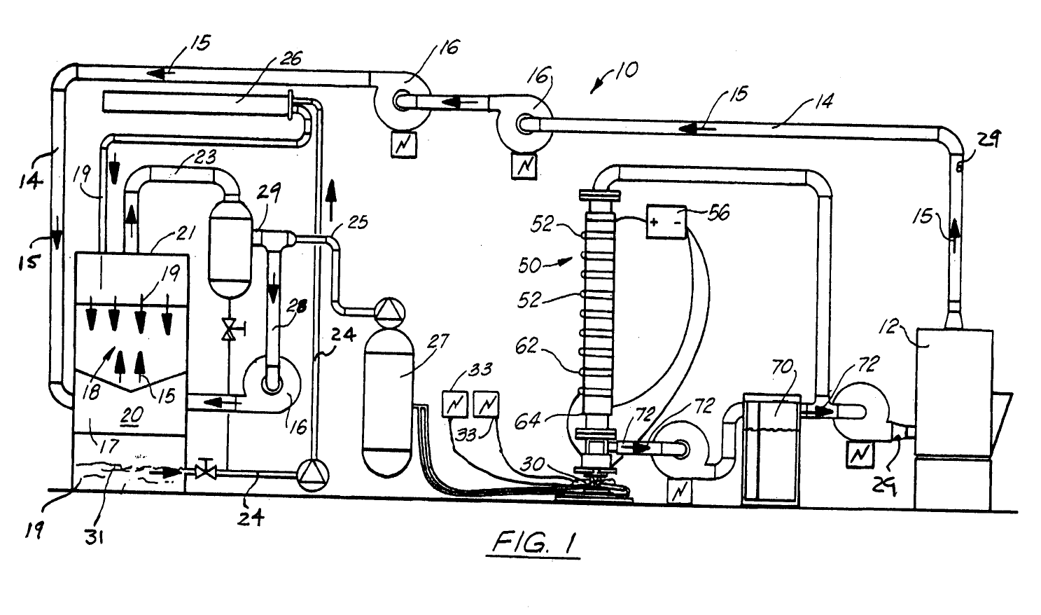

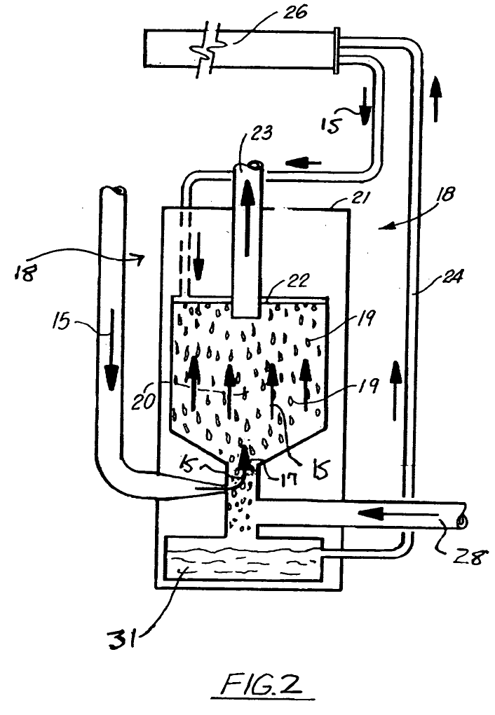

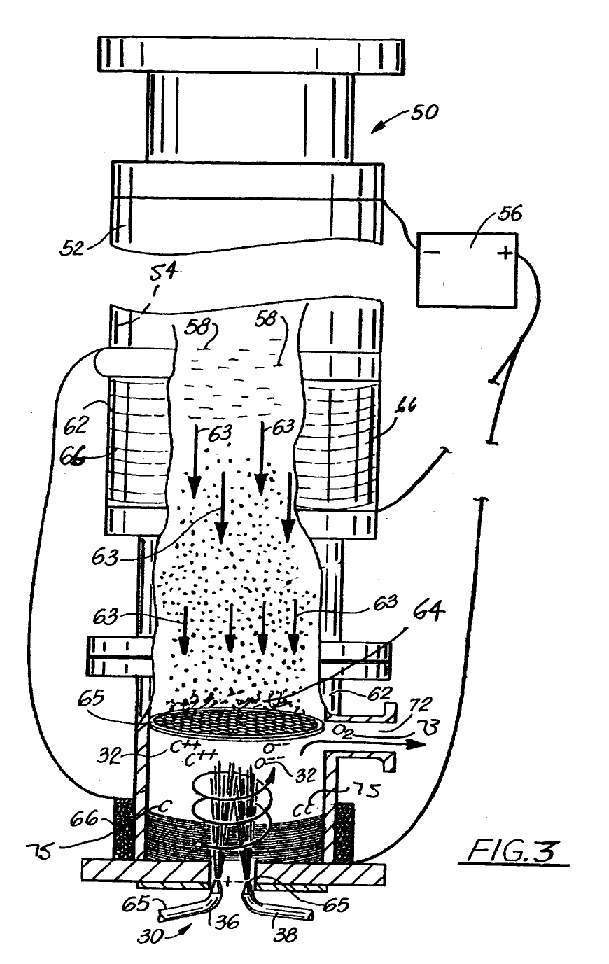

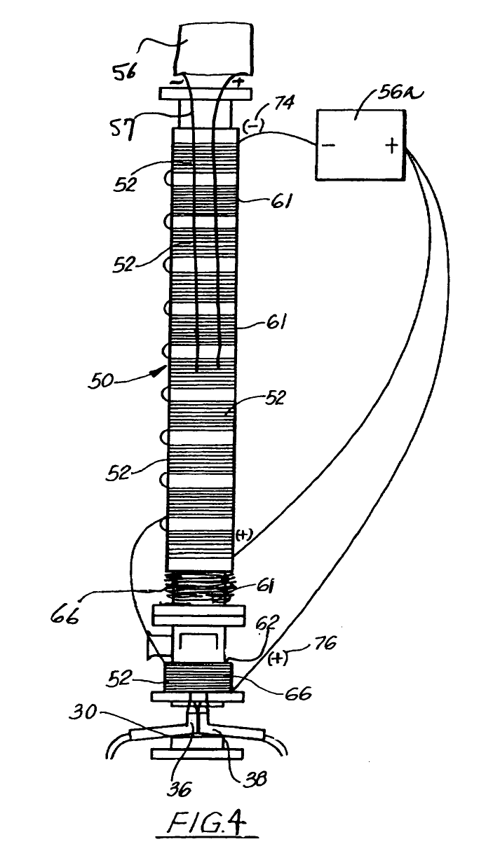

Turning to the Figures, reference is first made to FIG. 1, where there is illustrated a summary of the complete process 10 as will be described. First, there is provided a furnace 12 where there would be burned a fossil fuel, such as, but not limited to a biomass, coal, butane gas and oil. Such furnaces are common throughout the world in various industries. It is estimated that each year, some 4 million tons of coal is burned in such furnaces, which send approximately the same amount of CO₂ into the atmosphere. Referring again to FIG. 1, there is provided a conduit 14 which includes one or more fans 16, or equivalent devices, to pull the green house gases (represented by arrows 15) released from the burning of the coal. Such gases include CO₂, SO₂, CO, nitrogen products, represented by NOX, and hydrocarbons, represented by Chx, and perhaps others, including mercury. Next, the gases would enter a sequestration unit 18, as will be described more fully with reference to FIG. 2, where the gases 15 are cleaned and scrubbed in a bath of Inorganic Polymer Electret fluid (IPE) 19, which has been generated by the IPE generator 26. The scrubbed green house gases are then routed to a compressor 27, which reduces the volume of the gases, and sends them on to the conversion tower 50. The conversion tower 50 will be more fully described in FIGS. 3 and 4. The gases, before entering conversion tower 50, pass through a plasma arc 30, known in the art, which converts the green house gases, principally CO₂, to the charged ions of C++ and O−−, and other charged ions. The charged ions, within the tower 50, are then subjected to a dense electron field, created within the tower 50, whereby the charged ions are reduced to elemental C atoms, Oxygen gas, and other elements such as Silver and Mercury. The Oxygen is returned to the furnace 12 for re-use, and the elemental carbon, etc. is collected. Thus, there is no emissions of hydrocarbons from the process, in particular CO₂ gas. As seen in FIG. 1, there would in included a series of sample ports 29 throughout the system to sample the contents as the process progressed.

In FIG. 2 there is illustrated an isolated view of the sequestration unit 18, which was referenced earlier. From the furnace 12, a fan 16 directs the emitted greenhouse gases 15 through line 14 to the gas sequestration unit 18, where the gases are directed into the bottom 17 of a sequestration chamber 20. In the chamber 20, the gases 15 are moving upward from the bottom 17 while Inorganic Polymer Electret (IPE) fluid (arrows 19) is pumped from the IPE generator 26 into the top 21 of the chamber 20. Within the chamber 20, the gases 15 travel upward from the bottom of the chamber 20, and exit via conduit 23 (See FIG. 1), while the IPE fluid 19 rains down in into the chamber 20, providing a counter flow of IPE fluid 19 to the upward flow of the gases 15. In this process, the sequestration chamber 18 scrubs and cleans the gases very efficiently and over a short period of time. The novel sequestration unit 18 includes an IPE coil 22 for the Inorganic Polymer Electret (IPE), which is produced by IPE generator 26, whereby the CO₂ and the calcium from calcium carbonate form a colloid which sequesters the catalyst. The reaction is instantaneous. When the IPE fluid 19 is saturated with carbonate, the solution serves to treat the coal gas. The IPE fluid, as it is used, collects in a reservoir 31 at the bottom unit 18, where it is recycled via return line 24 to IPE generator 26.

Returning to FIG. 1, as the gases are recycled through the sequestration unit 18, a portion of the scrubbed gases 15 are allowed to flow through a second conduit 25, with the aid of a fan or other device 16, to be routed into a flue gas compressor 27. The remaining green house gases are re-cycled into the sequestration unit 18 via line 28 for additional treatment. Because of the treatment undergone in the sequestration unit 18, only the CO, CO₂, NOx, etc. comes out into the compressor 27. As an aside, after the gases 15 are compressed in compressor 27 to reduce the volume of the gases, one of the products is a light, crude hydrocarbon oil which can be collected on site.

Next, as illustrated in FIG. 3, remaining gases 15 which exit compressor 27 are introduced into a plasma arc 30, a unit known in the art, which allows compounds to be converted into charged particles, and is powered by plasma arc generator 33 (see FIG. 1). As the gases are introduced into plasma arc 30, the arc 30 increases the velocity of the gases, and as the gases travel between charged electrodes 36, 38 of the plasma arc 30, the gases, CO₂, CO, SO₂, etc. are converted and ionized to C++, O−−, S++ ions 32. Under normal conditions, when the charged ions would be released from the plasma arc 30, the ions would immediately recombine to form the gas molecules that were entering the arc 30. However, in order to avoid this, reference is made to the next step in the process.

The ions 32 exiting the arc 30 are then subjected to a dense electron zone 64, adjacent a titanium grid 65, whereby the charged positive ions 32, rather than combining with oxygen to form the gas molecules, would immediately flow into the free electron zone 64 and pick up free electrons from the dense electron zone at titanium grid 65, thereby converting the charged ions of carbon to elemental carbon fragments 75, such as carbon black or graphite. The charged negative oxygen ions 32 would be converted to oxygen gas molecules 73, which would flow from the tower 50 through line 72, to be returned to the furnace 12 to burn more fuel. In the process described, there may be converted hydrocarbon products, but the end result is the absence of CO₂ or other green gas molecules emitted into the atmosphere.

In order to accomplish the conversion as described with reference to FIG. 3, reference is made to the conversion tower 50, as seen in FIG. 4. Tower 50 comprises a series of electro-magnets 52, with each electro-magnet 52 surrounding a hollow cast iron core 54, or other suitable metal core. The tower 50 would receive free electrons 58 flowing into the tower, which would emanate from an electron accelerator 56, known in the art. The electron accelerator 56, through the use of a catalytic converter of tungsten rods, which is a high frequency electron source, captures the free electrons 58, and forces the electrons, via lines 57, in about 2 million watts of high frequency free electrons, into the tower 50, in high density up to 100,000 Hz, up to 20 million Hz. The plurality of magnets 52 are firing in sequence at the rate of approximately 40 times per second, which forces the free electrons 58 down the hollow core of tower 50, in the direction of arrows 63. When the electrons 58 reach the final two magnets 61, 62 the coils 66 of the magnets are wired in parallel, but in opposite polarity.

Therefore, when the electrons 58 enter this area, the electrons are repelled by the charged electro-magnets 61, 62, but are collected and captured on a titanium grid 65, and are trapped within the opposite polarized zone 64, causing a dense accumulation of electrons. The result is the formation of a dense electron pocket 64, estimated at some 2 million watts of free electrons, within the chamber 50, on the titanium grid 65, adjacent the exit nozzles 69 of the plasma arc 30, where the reduction of the charged ions into atoms takes place. At that instance, rather than the positively charged ions 32 picking up free electrons from the negatively charged oxygen ions 32, and the ions reverting back to the noxious green house gases, the carbon ions pick up electrons from the dense field of electrons 64, and are converted to elemental carbon fragments 75, such as carbon black or graphite. The negatively charged oxygen ions form oxygen gas molecules 73. The other charged ions of sulphur or mercury, also form elemental fragments and are deposited in the chamber. The oxygen, and some nitrogen, is routed back into the furnace 12, through line 72, in order to allow further burning of fossil fuel. Because of the large quantity of carbon fragments converted, the carbon is routed to a carbon trap 70, where the carbon is recovered. Any other carbon fragments, such as hydrocarbon fragments, result in the formation of oil or other component.

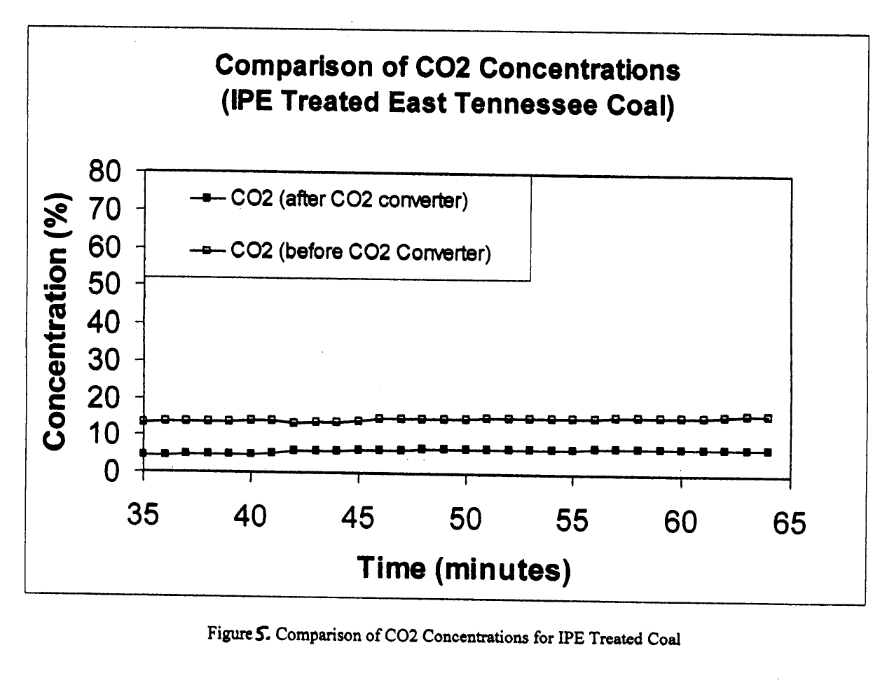

FIG. 5 represents test results of the comparison of CO₂ concentrations for IPE Treated East Tennessee Coal. Although the results are self-explanatory, it is shown that over 60+ minutes, the CO₂ concentration before going through the CO₂ convertor, contained concentrations of CO₂ above 10%, while after conversion the CO₂ concentrations dropped to below 10%.

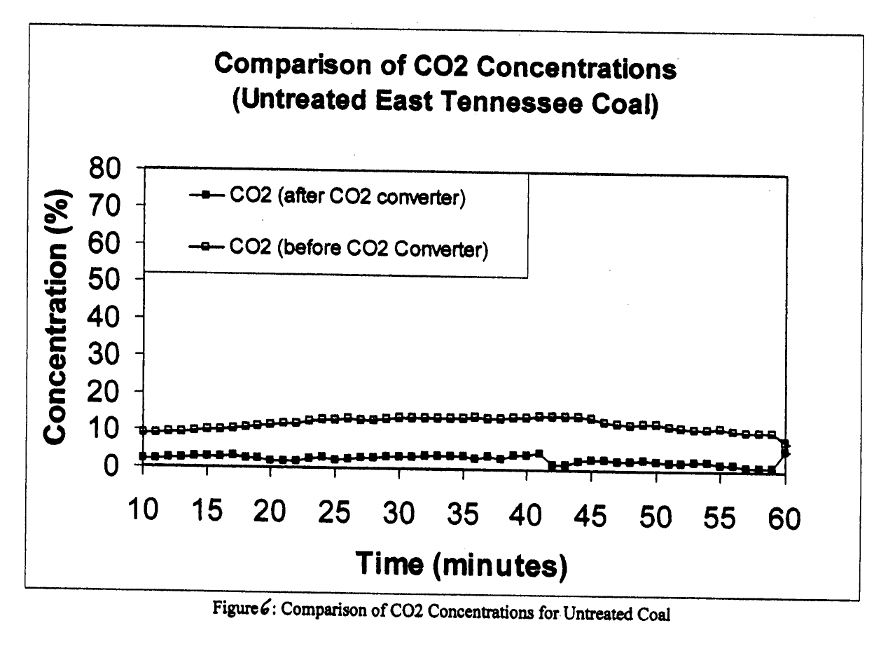

In FIG. 6, in a comparison of CO₂ concentrations for Untreated East Tennessee Coal, before going through the CO₂ convertor, the level of CO₂ concentration was around 10%, while after going through the convertor, the CO₂ concentration was slightly above or at 0% concentration.

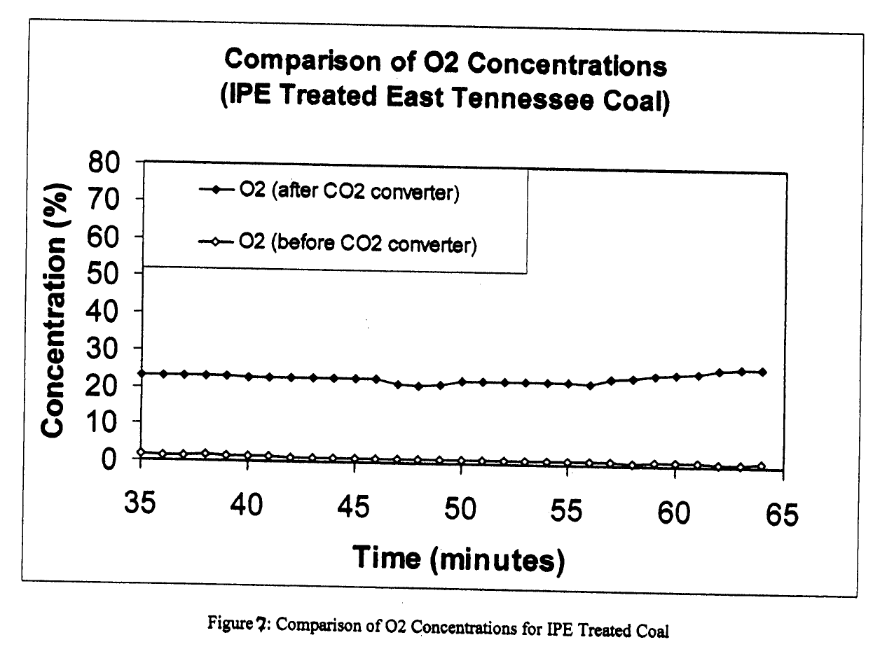

FIG. 7 represents test results of the comparison of O₂ concentrations for IPE Treated East Tennessee Coal. Although the results are self-explanatory, it is shown that over 60+ minutes, the O₂ concentration before going through the CO₂ convertor, contained concentrations of O₂ near 0%, while after conversion the O₂ concentrations increased to above 20%.

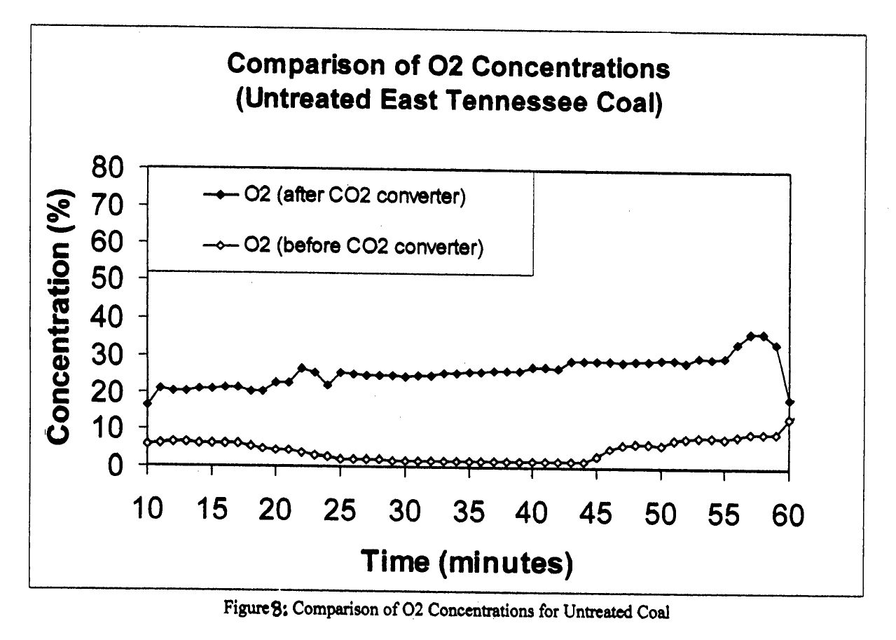

In FIG. 8, in a comparison of O₂ concentrations for Untreated East Tennessee Coal, before going through the CO₂ convertor, the level of O₂ concentration was around 5% at the onset, then down to almost 0% after 40+ minutes, and climbing to around 10+% at the end of the test period, while after going through the convertor, the O₂ concentration was slightly below 20% and rose throughout the test period to around 30+%, and dropping off to around 20% by the end of the test period.

CO₂ Test Findings

In tests conducted regarding CO₂ in the process, it has been determined that the following results have been observed:

1—The Furnace

Burning fossil fuel+O₂ results in CO₂

2—The Sequestration Chamber

CO₂ results in CaCO₃ (10%)+CO₂ (90%)

3—The Compressor

CO₂ results in compressed CO₂

4—The CO₂ Converter

CO₂ results in O₂+C fragments

5—The Carbon Water Trap

O₂+C result in O₂ released

Green House Gas Test Findings

In treating green house gas containing other components in addition to CO₂, the following results were observed:

1—The Furnace

Fossil fuel burning in 21% O₂ results in Heat+CO₂ (10%)+CO (1%)+SO₂ (CaSO₄)

Green House Gases result in NO (60 ppm)+NO2 (100 ppm)+CHX (hydrocarbons) (1.2 ppm)+O₂ (9-10%)

2—Sequestration Chamber

CO₂, SO₂, CO, NOX and CHX result in CO₂₁ CaSO₄, H₂O, CO, NOX, CHX and CaCO₃

3—Compressor

CO₂, CO, NOX and CHX components remained unchanged but in a reduced volume.

4—CO₂ Converter

CO₂₁ CO, NOX, CHX result in (C)n, O₂, and N₂

5—Carbon Water Trap

(C)n, O₂ and N₂ result in O₂ and NO₂

Plasma Arc/Converter Process

When the CO₂ is subjected to the electrodes of the plasma arc, unstable C++ ions and unstable O−− ions are the result. When immediately contact is made with the high density electron field in the tower, the C++ are converted to (C)n fragments in the form of carbon black and graphite, and the unstable O−− ions are converted to O₂ molecules.

For purposes of disclosure only this application incorporates by reference the following patent applications. The present application is not a continuation, divisional, or a continuation-in-part of any of the applications referenced below.
“Apparatus and Process for Generating Electric Power by Utilizing High Frequency High Voltage Oscillating Current as a carrier for high EMF DC in an Armature Board,” filed Oct. 27, 2003, bearing Ser. No. 10/694,326;
“Emissions Free High Efficiency Coal Fired Power Generation Plant,” filed on Aug. 27, 2003, bearing serial No. 60/498,050;
“Apparatus and Process For Generating Electric Power by Utilizing High Frequency High Voltage Oscillating Current as a carrier for high EMF DC in an Armature Board Composed of laminated Steel and Wound with Exciter Circuits in Proximity to a Stator Board of laminated Steel Wound with a Collector Coil and Separated by an Air Gap and Aluminum Screen Wire to Contain the High Frequency Within the Armature Board,” filed Oct. 23, 2002, bearing Ser. No. 60/421,097;
“Apparatus and Process for Generating Electric Power by Alternating Fields of High Frequency and High Voltage Which Generate Pulsating Fields Which In Turn PushElectrons Across Static Magnetic Flux Fields of the Invention and Collecting the Current on Collector/Conductor Coils Co-wound with the Exciter Coils,” filed on Jan. 24, 2002, bearing Ser. No. 60/351,655;
“Apparatus and Process for Converting the Force of Gravity to Useable Mechanical and/or Electrical Energy,” filed Jan. 23, 2001, bearing Ser. No. 60/264,394;
“Apparatus and Process for Converting The Force of Gravity Combined with Magnetic levitation To Usable Mechanical and/or Electrical Energy,” filed Feb. 23, 2001, bearing Ser. No. 60/271,224;
“Apparatus and Process for Converting the Formula and Operating of the Windings in Power Generating Equipment and Electric Motors to an increased Efficiency, By Removing the Power Reaction Force or Drag and Decreasing the Resistance in the Coils,” filed Jul. 4, 2001, bearing Ser. No. 60/303,662;
“Apparatus and Process for Generating Electric Power by Alternating Fields of High Frequency, High Voltage Across Static Magnetic Flux Fields and Collecting the Current on Collector/Conductor Coils Co-wound with the Exciter Coils,” filed Jul. 16, 2001, bearing Ser. No. 60/305,635;
“Description of an Inorganic Polymer Electret in a Colloidal State along with the Method of Generating and Applications,” filed Dec. 26, 2000, bearing Ser. No. 09/749,243;
“Apparatus and Process for Treating Coal which is High in Sulfur such that it will Burn in a High Temperature Furnace with Greatly Reduced Emissions of Sulfur Dioxide (SO₂) Nitrous Oxide and Mercury,” filed Mar. 28, 2001, bearing Ser. No. 60/279,325; and
“Reducing Sulfur Dioxide Emissions from Coal Combustion,” filed Mar. 28, 2002, bearing serial no. W02/079356.

### PARTS LIST

The following is a list of suitable parts and materials for the various elements of the preferred embodiment of the present invention.
process 10
furnace 12
conduit 14
fan 16
green house gases (arrows) 15
bottom 17
gas sequestration unit 18
IPE fluid 19
chamber 20
top 21
IPE coil 22
conduit 23
line 24
second conduit 25
IPE generator 26
gas compressor 27
line 28
plasma arc 30
IPE reservoir 31
ions 32
plasma arc generator 33
electrodes 36, 38
conversion tower 50
electro-magnets 52
cast iron core 54
electron accelerator 56
free electrons 58
electro-magnets 61, 62
arrows 63
dense electron zone 64
titanium grid 65
coils 66
exit nozzles 69
carbon trap 70
line 72
Oxygen molecules 73
Carbon fragments 75
   The foregoing embodiments are presented by way of example only; the scope of the present invention is to be limited only by the following claims.

1. A method of converting CO₂ or other green house gases into useful elemental components, comprising the steps of:
a. ionizing the green house gas, such as CO₂, into charged elements;
b. exposing the charged elements to an external electron field of sufficient electron density to competitively inhibit the re-oxidation of the carbon fragments and other green house gas fragments.

2. The method in claim 1, wherein the other green houses gases comprise SO₂, Nox, and CO and hydrocarbons.

3. The method in claim 1, wherein the ionizing of the green house gas, such as CO₂, is undertaken through a plasma arc.

4. The method in claim 1, wherein the step of providing sufficient electron density comprises a magnetic chamber generated by sequential electromagnets in a series, so that the last electromagnet is wired in parallel with a magnetic coil below the arc of opposite polarity to define a dense electron field for preventing the re-oxidation of the carbon.

5. The method in claim 1, wherein the CO₂ gas is fed into a sequestration chamber containing Inorganic Polymer Electret prior to ionization.

6. The method in claim 1, wherein the CO₂ gas undergoes compression before the ionization step.

7. The method in claim 1, wherein following the exposure of the elements to the electron field, the carbon is collected as elemental carbon or graphite, and the oxygen forms O₂ gas to be re-fed into a furnace for burning fossil fuel.

8. The method in claim 1, wherein the reduction of the green house gases, such as CO₂, to base elements occurs on a titanium grid positioned adjacent the plasma arc.

9. In a furnace, where green house gases are produced as off gases, a method of converting the green house gases into useful elemental components, comprising the steps of:
a. ionizing the green house gases into charged elements;
b. exposing the charged elements to an external electron field of sufficient electron density to competitively inhibit the re-oxidation of the carbon fragments and other green house gas fragments, which results in elemental carbon, oxygen gas, and other elemental fragments.

10. The method in claim 9, wherein the green house gases are from the group consisting of CO₂, CO, Sox, Nox, and other noxious gases.

11. A system for producing carbon fragments and oxygen from CO₂ gas emitted from a fossil fuel furnace, comprising:
a. means for collecting the CO₂ gas produced from the furnace;
b. a sequestration chamber for cleaning and scrubbing the CO₂ gas;
c. a compressor for compressing the scrubbed gas;
c. a means for initially ionizing the CO₂ gas to carbon fragments and oxygen; and
d. means for providing an external electron field of sufficient electron density to competitively inhibit the re-oxidation of the carbon fragments.

12. The system in claim 11, further comprising means for collecting the carbon fragments and the resulting O₂ gas.

13. The system in claim 11, wherein the entire system is a closed-loop system devoid of gaseous or solids emissions into the atmosphere.

14. The system in claim 11, wherein the means for collecting the CO₂ gas from the furnace comprises a flow pipe.

15. The system in claim 11, wherein the means for ionizing the CO₂ comprises a plasma arc.

16. The system in claim 11, wherein the means for providing the external electron field comprises a series of electro-magnets positioned so as to provide a zone wherein free electrons accumulate adjacent the plasma arc to provide free electrons for converting the charged ions of carbon and oxygen to elemental fragments.

17. A method of converting green house gases, such as CO₂, CO, SO₂, NO₂, and others, into useful elemental components, comprising the steps of:
a. scrubbing the green house gases in a sequestration chamber;
b. compressing the green house gases to reduce their volume;
c. ionizing the green house gases into charged ions; and
d. exposing the charged ions to an external electron field of sufficient electron density to competitively inhibit the re-oxidation of the carbon fragments and other green house gas fragments.

18. The method in claim 17, wherein the collected fragments comprise elemental carbon in the form of carbon black or graphite; oxygen gas, hydrocarbon oils, and sulphur and nitrogen fragments.

19. The method in claim 17, wherein the green house gases are converted to charged ions by a plasma arc unit.

20. The method in claim 17, wherein the external electron field results in the accumulation of free electrons trapped within a charged magnetic field adjacent the formation of the charged ions released from the plasma arc.

21. The method in claim 17, wherein the sequestration chamber further comprises an inorganic polymer electret to enhance the scrubbing of the green house gases.
